(19) United States
(12) Patent Application Publication
(10) Pub. No.: US 2010/0145607 A1
(43) Pub. Date: Jun. 10, 2010

(54) PATH CALCULATION METHOD BASED ON LOCATION INFORMATION

(76) Inventors: Xudong CHEN, Shanghai City (CN); Tony Tsai, Taipei County (TW)

Correspondence Address: Muncy, Geissler, Olds & Lowe, PLLC, 4000 Legato Road, Suite 310, FAIRFAX, VA, 22033, US

(21) Appl. No.: 12/633,005

(22) Filed: Dec. 8, 2009

(30) Foreign Application Priority Data
Dec. 8, 2008 (TW) 097147642

(51) Int. Cl. G01C 21/36; H04W 64/00; H04W 4/12

(52) U.S. Cl. 701/201; 455/456.1; 455/466

(57) ABSTRACT

A path calculation method based on location information is provided. The method is applied to a navigation device. In this method, the navigation device obtains information of a location transmitted by an electronic device. The location information is a text information or a picture. The navigation device obtains information of a coordinate contained in the location information, a starting road name to which its own location belongs and a corresponding starting point, as well as a navigation road name to which the coordinate information belongs and a corresponding navigation point. The navigation device then calculates a best navigation path according to the above information through a global positioning system (GPS). By this method, the navigation device may perform navigation path planning or calculation upon reading the location information, so as to shorten time for a user to input text and coordinates.

### CROSS-REFERENCE TO RELATED APPLICATION

This application claims the benefit of Taiwan Patent Application No. 097147642, filed on Dec. 8, 2008, which is hereby incorporated by reference for all purposes as if fully set forth herein.

### BACKGROUND OF THE INVENTION

1. Field of Invention

The present invention relates to a navigation method, and more particularly to a path calculation method based on location information.

2. Related Art

In all global positioning systems (GPSs) of existing navigation machines in the prior art, no matter the GPS is used in car navigation, or in pedestrian navigation, it is designed that a user first sets a starting point, an ending point, navigation preferences (such as a shortest path, a lightest road traffic, and entering/not entering special roads), and then the navigation machine utilizes the GPS to perform navigation according to the previous settings.

For convenience of a user, a map database is improved by providing drawings or illustrations for special scene spots. The user may set these scene points as points of interest (POI), and store the POIs in the database of the navigation machine (for example, my favorites). Also, the user may further store commonly used or important navigation results in the database of the navigation machine for use in the future.

However, the prior art may still be improved in several aspects.

First, the scene points stored in navigation machines currently are usually updated by the Internet. Although scene point data or pictures from friends or web pages have navigation coordinates or addresses, the user still has to input the navigation coordinates or addresses manually in text or numerals with the navigation machine, before navigation works. Input operation for a user is still complicated and difficult.

Second, currently all digital photographs have an Exchangeable Image File Format (Exif). Coordinates for navigation may be stored within the photographs. But the user needs to read this type of pictures with image browsing tools, obtains coordinates for navigation, and manually inputs this type of navigation coordinates or addresses in text or numerals with the navigation machine before the navigation works. Navigation operation for a user becomes more complicated and difficult.

### SUMMARY OF THE INVENTION

In view of this, the present invention is directed to a path calculation method based on coordinate information recorded within the location information, no matter where the location information is obtained, so as to decrease inconveniences of text input by a user, and shorten an input time.

For the purpose above, the present invention provides a path calculation method based on location information. The method is applicable to a navigation device. The navigation device obtains information of a location transmitted by an electronic device, so as to obtain information of a coordinate contained in the location information. The navigation device takes a location of the navigation device as a starting coordinate, matches the starting coordinate in a map database in the navigation device, so as to obtain a starting road name corresponding to the location of the navigation device and a starting point corresponding to the starting road name. The navigation device matches the coordinate information in the map database, so as to obtain a navigation road name and a navigation point corresponding to the navigation road name. The navigation device calculates a navigation path through a global positioning system (GPS) according to the starting road name, the starting point, the navigation road name, and the navigation point.

The present invention may achieve the following effects.

First, with this method, the navigation device may perform calculation of a navigation path no matter where the location information is obtained, without manually inputting related coordinates or addresses, thereby effectively reducing the difficulties and complexities of the path navigation and shortening the input time.

Second, the location information is a picture or a text information. The location information may be downloaded from the Internet by a user, or may be communicated among friends via the network with electronic devices. In addition, the user may use a cell phone with a GPS and a camera, or a digital camera embedded with a GPS to photograph a scene point, so as to get pictures and photos with navigation coordinates. When the user wants to visit the scene point again in the future, the user only has to load the pictures, or the coordinate information contained in the pictures which are acquired beforehand to the navigation device, and the path navigation calculation is then started.

Third, when the user of the electronic device and the user of the navigation device are the same person, the user may transmit the location information of a destination with the electronic device to the navigation device, so as to simplify the navigation. If the user of the electronic device and the user of the navigation device are different persons, the navigation device may plan or calculate a navigation path between the navigation device and the electronic device according to the location information provided by the electronic device, so as to guide the user of the navigation device to head for the location of the user of the electronic device.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method of an embodiment according to the present invention;

FIG. 2 is a schematic view of an exchangeable image file format of an embodiment according to the present invention;

FIG. 3 is a schematic sectional view of an electronic device of an embodiment according to the present invention;

FIG. 4 is a schematic view of picture transfer of an embodiment according to the present invention; and

FIG. 5 is a schematic view of picture obtaining of an embodiment according to the present invention.

### DETAILED DESCRIPTION OF THE INVENTION

To provide a better understanding of the objectives, structure features, and functions of the present invention, the present invention is illustrated in detail in conjunction with related embodiments and drawings.

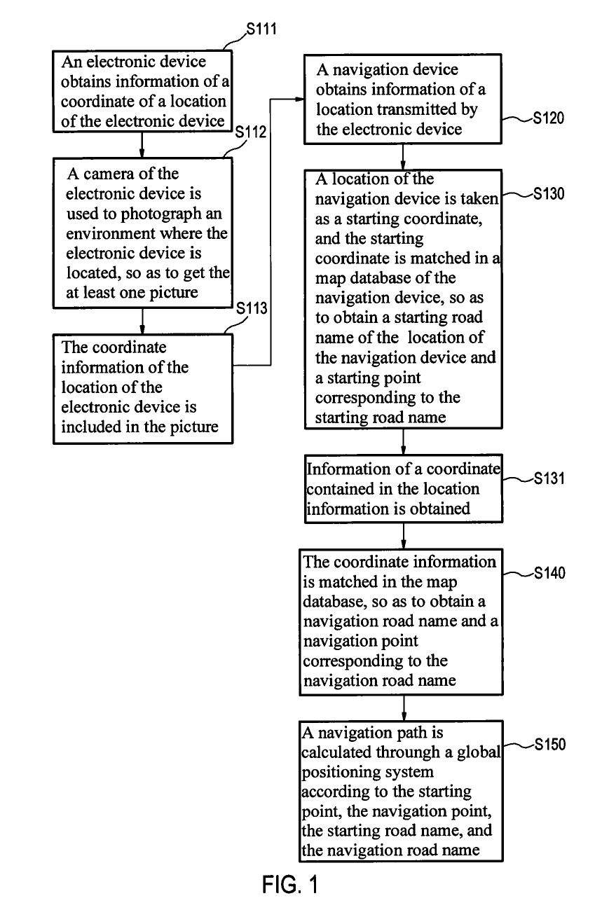

FIG. 1 is a flow chart of a method according to an embodiment of the present invention.

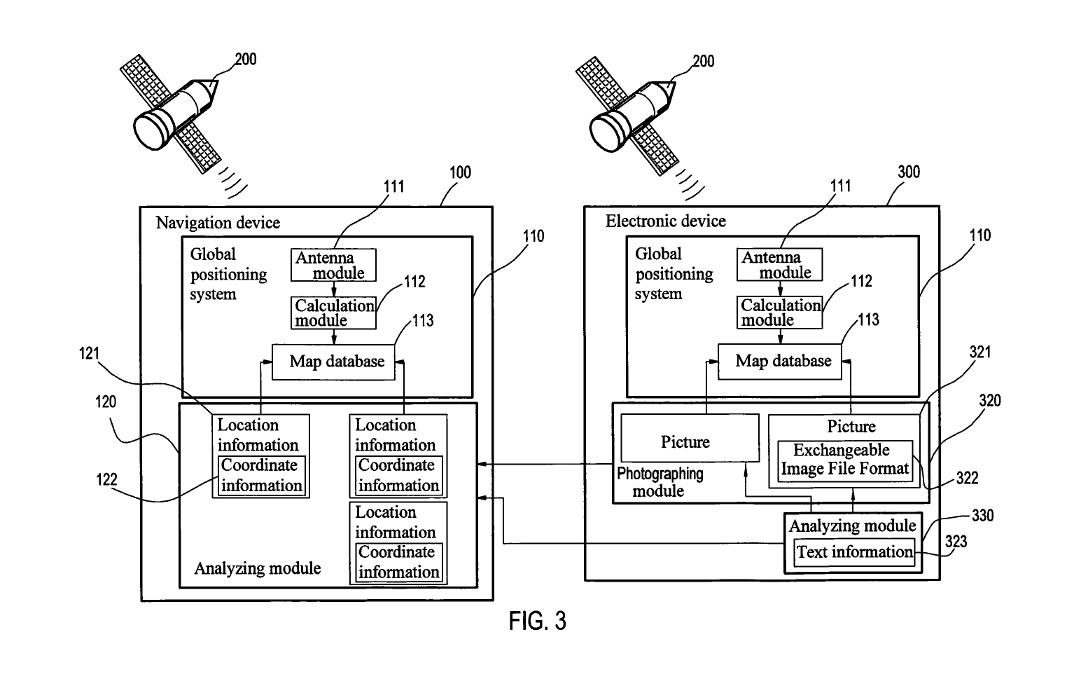

The method is applied to a navigation device 100. Referring to FIG. 3 at the same time, in this embodiment, the navigation device 100 is equipped with a global positioning system (GPS) 110. The method includes the following steps.

At least one location information 121 is stored in an electronic device 300. This step mainly illustrates that before navigation path calculation, one or more location information 121 needs to be prepared. This type of location information 121 is a picture 321 or a text information 323. If the location information 121 is the picture 321, the picture 321 is a photo of a scene at a certain spot.

The picture 321 includes the coordinate information 122 of this spot. The methods for storing the coordinate information 122 include the following two. The picture 321 has an Exchangeable Image File Format (Exif) 322, and the coordinate information is recorded within this Exif format 322. Or, the coordinate information 122 is included in a graphic of the picture 321 directly.

The location information 121 may be prepared with the following steps.

The electronic device 300 obtains information of a coordinate of a location of the electronic device 300 (step S111). As shown in FIG. 3, the electronic device 300 is embedded with the GPS 110. The GPS 110 includes an antenna module 111, a calculation module 112, and a map database 113. The antenna module 111 obtains a positioning signal sent by a satellite 200. The calculation module 112 analyzes the coordinate information 122 of the electronic device 300 according to the positioning signal. A camera 320 of the electronic device 300 is then used to photograph an environment where the electronic device 300 is located, so as to get the at least one picture 321 (step S112), and the coordinate information 122 of the location of the electronic device 300 is included in the picture 321 (step S113).

The method of storing the coordinate information 122 is as discussed above, i.e., storing the coordinate information 122 with the Exif format 322 of the picture 321, or storing the coordinate information 122 in the graphic of the picture 321. For purpose of convenience, the electronic device 300 may be a commercially available cell phone in which the a GPS 110 and a camera 320 are built or a digital camera in which the GPS 110 is built. Both the cell phone and the digital camera are capable of photographing a Geo Photo. Acquired photos or pictures include an Exif format 322 having coordinates of the photograph location. Or, the coordinates of the photograph location are directly displayed in the graphic of the picture 321, which may be seen by the user directly.

Alternatively, the electronic device 300 only records the coordinate information of the photograph location, so as to form the text information 323 in a text format.

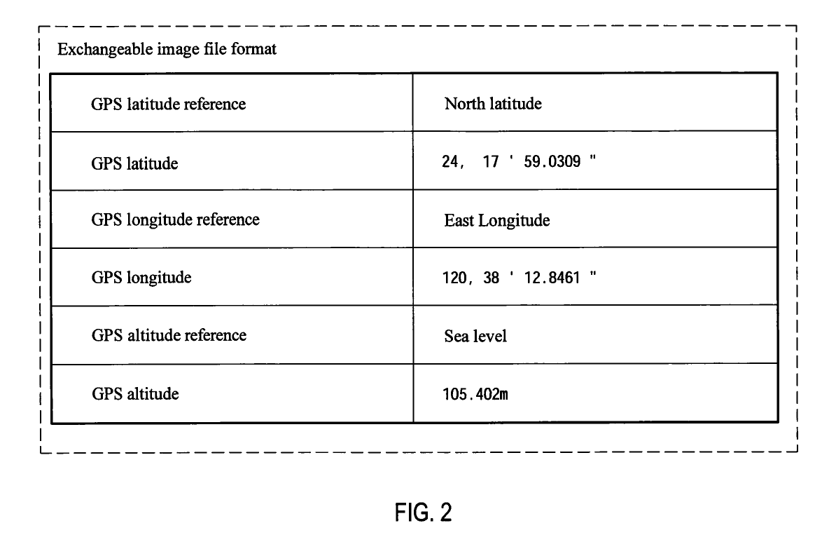

As for the path navigation operation, the navigation device 100 obtains information of a location transmitted by the electronic device 300 (step S120). As shown in FIGS. 2 and 3, if the location information 121 is the picture 321 and has the Exif format 322, the coordinate information 122 will be recorded in the Exif format 322. Or, if the location information 121 is the picture 321, the coordinate information 122 is included directly in the graphic of the picture 321. Or, the location information 121 may be a text information in a pure text format. It should be noted that if the location information transmitted by the foregoing electronic device 300 is not generated by the electronic device 300 after finishing photograph operation, and is obtained in other ways instead, the coordinate information contained in the location information obtained by the navigation device 100 is different from the coordinate information generated by photographing of the electronic device 300. On the contrary, if the location information transmitted by the electronic device 300 is generated by the electronic device 300 after finishing the photograph operation, the coordinate information contained in the location information obtained by the navigation device 100 is the same as the coordinate information generated by photographing of the electronic device 300.

The navigation device 100 may obtain the location information 121 in several ways.

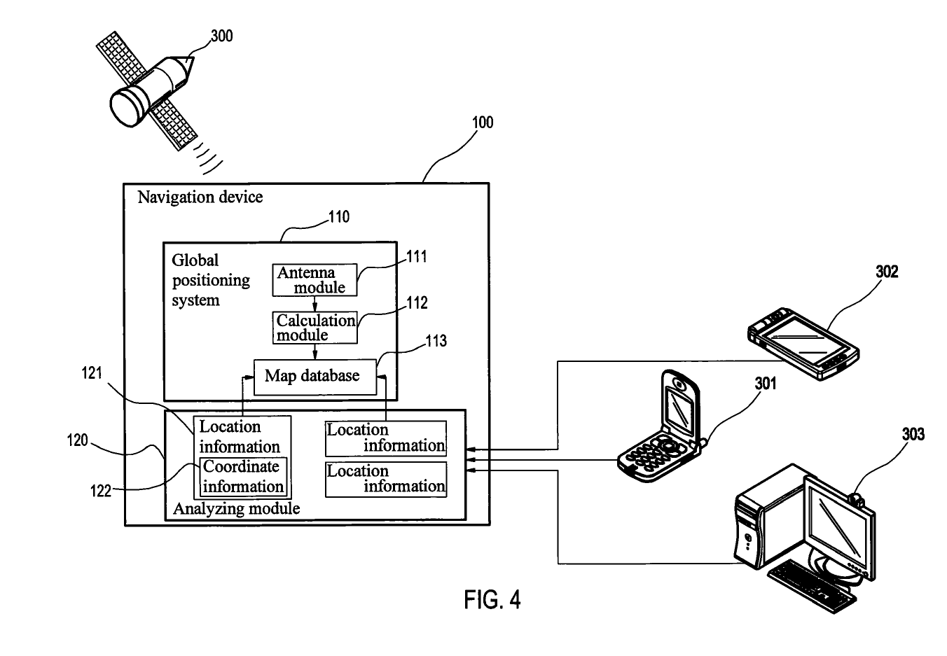

First, the location information 121 is included in the foregoing electronic device 300. The electronic device 300 may be the above mentioned cell phone 301 in which the GPS 110 and the camera are built, or the digital camera in which the GPS 110 is built. Or, as shown in FIG. 4, the electronic device 300 is a server, a computer 303, a cell phone 301, or a personal digital assistant (PDA) 302 stored with the location information 121. The electronic device 300 transmits the location information 121 to the navigation device 100 by the use of information transmission methods such as Multimedia Messaging Service (MMS), Wireless Application Protocol (WAP), or Simple Mail Transfer Protocol (SMTP).

It should be noted that, when the location information 121 is the picture 321, and the user of the electronic device 300 finds it impossible to transmit the picture 321 to the navigation device 100 by the use of the methods such as MMS and WAP, the electronic device 300 may acquire the coordinate information 122 contained in the picture 321 beforehand to get the above mentioned text information 323, and then transfer the text information 323 to the navigation device 100 by transmitting an e-mail in a text format with Short Message or SMTP.

However, when the coordinate information is contained in the graphic of the picture, the electronic device 300 requires an analyzing module 330 capable of optical character recognition (OCR), so as to analyze the coordinate information 121 contained in the graphic 321. When the coordinate information 121 is recorded in the Exif format 322 of the picture 321, the analyzing module 330 of the electronic device 300 needs to be capable of reading the Exif format 322.

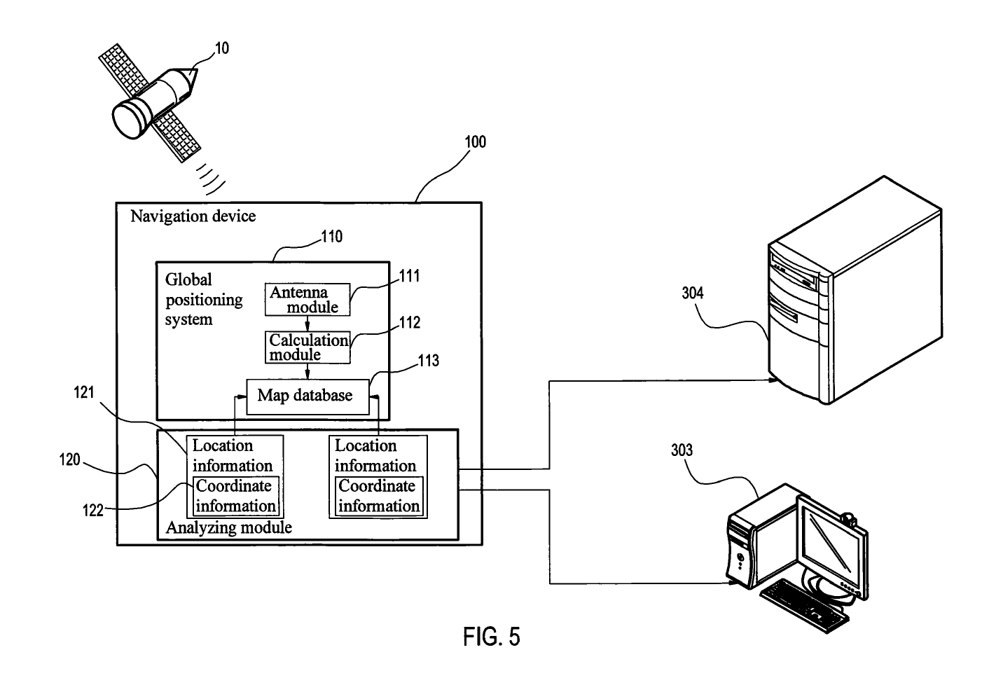

Second, as shown in FIG. 5, when the electronic device 300 is a computer 303 or a server 304, the navigation device 100 downloads and stores the location information 121 from the computer 303 or the server 304 by using Hypertext Transfer Protocol (HTTP) or File Transfer Protocol (FTP).

Next, a location of the navigation device 100 is taken as a starting coordinate, and the starting coordinate is matched in the map database 113 of the navigation device 100. A starting road name corresponding to the location of the navigation device 100 and a starting point corresponding to the starting road name are obtained (step S130).

The purpose of analyzing a starting road name to which the navigation device 100 belongs and a corresponding starting point is that the navigation device 100 may be at some special spots such as a certain building, a field, a path in a mountain forest rather than at roads that may be navigated. Thus, the navigation device 100 first decides a most possible road corresponding to the starting coordinate of the navigation device 100, decides a most possible road section location of the road corresponding to the starting coordinate as a starting point, and finally performs the subsequent navigation operation.

The information of a coordinate contained in the location information is obtained (step S131). This step has a plurality of ways, which different from one another mainly according to a type of the location information.

First, when the location information 121 is the picture 321 having the Exif format 322, and the coordinate information 122 is stored in the Exif format 322, the analyzing module 120 disposed in the navigation device 100 needs to be capable of read the Exif format 322.

Second, when the location information 121 is the picture 321, and the picture 321 includes the coordinate information 122, the analyzing module 120 disposed in the navigation device 100 needs to be capable of analyzing text included in the graphic 321, so as to obtain the coordinate information 122.

Third, when the location information 121 is the text information 323 in a text format, such as a short message or an e-mail where text is stored, the analyzing module 120 only needs to be capable of read the coordinate information contained therein.

Fourth, when the navigation device receives several location information 121 in the same or different data formats, different analyzing modules 120 or a multifunctional analyzing module 120 may be provided, so as to integrate the above mentioned three ways to analyze the coordinate information 122 contained in respective location information 121.

The coordinate information is matched in the map database 113, so as to obtain a navigation road name and a navigation point corresponding to the navigation road name (step S140). The step is the same as the step S131, the location of the coordinate information corresponding to the scene point may not be at roads that may be navigated. Thus, the navigation device 100 first decides a most possible road corresponding to the coordinate information 122, decides a most possible road section location of the road corresponding to the coordinate information 122 as a navigation point, and finally performs the subsequent navigation operation.

At last, the navigation device 100 calculates a navigation path with the GPS 110 according to the starting point, the navigation point, the starting road name, and the navigation road name (step S150). While the navigation device 100 may perform the path navigation according to a plurality of different preference settings, such as, a shortest path, a lightest road traffic, entering/not entering a special road (for example, high way, express road), decreasing the number of crossing roads of opposite direction, inevitable special spots (for example, POI, scene points, stores, suburbs).

When the navigation device 100 obtains the information of multiple-location information 121, the navigation device 100 first analyzes the information of multiple coordinates contained in the multiple-location information 121. Next, the navigation device loads the multiple-location information into the GPS 110. The navigation device then matches the multiple-coordinated information in the map database to obtain multiple navigation road names and multiple navigation points corresponding to the multiple navigation road names. The navigation device 100 then calculates a navigation path according to the multiple navigation road names, multiple navigation points, starting road names, and starting points by calculation rules. The calculation rules have the following three rules.

First, the navigation device 100 plans or calculates a navigation path according to a sequence in which the navigation device obtains the multiple-location information 121, or loads the multiple-location information into the GPS 110.

Second, the navigation device 100 analyzes the distance between the multiple-coordinate information and the starting point, and then plans or calculates the navigation path according to the distance.

Third, the user inputs a sequence of the location information 121 through an interface of the navigation device 100, and the navigation device 100 plans or calculates a navigation path accordingly.

However, the method mainly analyzes the starting point, the navigation point, the starting road name, and the navigation road name to perform navigation. Thus, step S130 does not have a sequential relation with step S120, step S131, and step S140. Step S130 may be randomly adjusted among the three steps. Moreover, step S131 may even be integrated into step S120, as long as analysis of the starting point, the navigation point, the starting road name, and the navigation road name is finished before step S150.

Although the present invention is disclosed with foregoing preferred embodiments, those embodiments are not used to limit the present invention. Equivalent replacements for variations and modifications made by any skilled in the art still remain within the patent coverage of the present invention without departing the spirit and scope of the present invention.

What is claimed is:

1. A path calculation method based on location information, applicable to a navigation device, comprising:
the navigation device obtaining information of a location transmitted by an electronic device;
using a location of the navigation device as a starting coordinate, matching the starting coordinate in a map database of the navigation device to obtain a starting road name corresponding to the location of the navigation device and a starting point corresponding to the starting road name;
obtaining information of a coordinate contained in the location information;
matching the coordinate information in the map database to obtain a navigation road name and a navigation point corresponding to the navigation road name; and
the navigation device calculating a navigation path according to the starting point, the navigation point, the starting road name, and the navigation road name through a global positioning system (GPS).

2. The method according to claim 1, wherein the location information comprises a picture, a format of the picture comprises Exchangeable image file format (Exif), and the coordinate information is stored in the Exif format.

3. The method according to claim 1, wherein the location information comprises a picture, a graphic of the picture contains the coordinate information, and the step of obtaining the coordinate information comprises acquiring the graphic of the picture through a text analyzing module of the navigation device, so as to obtain the coordinate information.

4. The method according to claim 1, wherein the location information comprises text information containing the coordinate information.

5. The method according to claim 4, wherein the text information comprises a short message or an e-mail in a text format.

6. The method according to claim 1, wherein before the navigation device obtains the location information transmitted by the electronic device, the method further comprises storing the location information in the electronic device.

7. The method according to claim 6, wherein the step of storing the location information in the electronic device comprises:
the electronic device obtaining information of a coordinate of a location of the electronic device;
using a camera of the electronic device to photograph an environment where the electronic device is located, so as to get at least one picture; and
including the coordinate information of the location of the electronic device in the picture.

8. The method according to claim 7, wherein the format of the picture comprises the Exif format, and the coordinate information of the location of the electronic device is stored in the Exif format.

9. The method according to claim 7, wherein a graphic of the picture contains the coordinate information of the location of the electronic device.

10. The method according to claim 7, wherein the electronic device comprises a cell phone in which the GPS and the camera are built, or a digital camera in which the GPS is built.

11. The method according to claim 1, wherein the electronic device transfers the location information to the navigation device through an information transmission method.

12. The method according to claim 11, wherein the electronic device comprises a server, a computer, a cell phone, or a personal digital assistant (PDA).

13. The method according to claim 11, wherein the information transmission method comprises Multimedia Messaging Service (MMS), Wireless Application Protocol (WAP), or Simple Mail Transfer Protocol (SMTP).

14. The method according to claim 1, wherein a connection between the navigation device and the electronic device comprises a means of a network communication mode, so as to obtain the location information.

15. The method according to claim 14, wherein the electronic device comprises a server, a computer, a cell phone, or a PDA.

16. The method according to claim 14, wherein the network communication mode comprises Hypertext Transfer Protocol (HTTP) or File Transfer Protocol (FTP).

17. The method according to claim 1, wherein the navigation device obtains information of multiple locations transmitted by the electronic device, the multiple-location information contains information of multiple coordinates, the step of matching the coordinate information comprises matching the multiple-coordinate information in the map database to obtain multiple navigation road names and multiple navigation points corresponding to the multiple navigation road names, and the step of calculating the navigation path comprises the navigation device calculating the navigation path according to the multiple navigation road names, the multiple navigation points, the starting road name, and the starting point by a calculation rule.

18. The method according to claim 17, wherein the calculation rule is that the navigation device calculate the navigation path according to a sequence in which the navigation device obtains the multiple-location information.

19. The method according to claim 17, wherein the calculation rule is that the navigation device calculate distances between the multiple-coordinate information and the starting point, and then calculate the navigation path according to the distances.

20. The method according to claim 1, wherein the navigation device comprises a server, a computer, a cell phone, or a PDA.
